(19) United States
(12) Patent Application Publication
(10) Pub. No.: US 2003/0182454 A1
(43) Pub. Date: Sep. 25, 2003

(54) Header compression method for network protocols

(76) Inventors: Hans-Peter Huth, Munich (DE); Robert Kutka, Gletendorf (DE); Juergen Pandel, Feldkirchen-Westerham (DE)

Correspondence Address: MORRISON & FOERSTER LLP, 1650 TYSONS BOULEVARD, SUITE 300, MCLEAN, VA, 22102, US

(21) Appl. No.: 10/333,773

(22) PCT Filed: Jul. 20, 2001
(86) PCT No.: PCT/DE01/02740

(30) Foreign Application Priority Data
Jul. 25, 2000 (DE) 100 36 149.8
Jan. 11, 2001 (DE) 101 01 089.3

(51) Int. Cl. G06F 15/16

(52) U.S. Cl. 709/247

(57) ABSTRACT

The invention relates to an encoding method, which uses statistical characteristics of all types of network protocols without requiring specific knowledge of the definitions of individual protocol fields. Network protocols in general contain long contiguous sections, which remain unchanged. Said sections are therefore predicted from the preceding header and do not need to be transmitted. The position of the modified and unmodified fields is also predicted, so that in most cases, transmission of the position co-ordinates is not necessary. Said principle, together with a corresponding differential encoding, achieves a high data compression, as only the modified data and a small amount of overhead need to be transmitted.

The invention relates to a method for compression of header information in network protocols, to a method for decompression of correspondingly compressed header information, as well as to corresponding encoders/decoders and transmitting/receiving units.

One problem that has already existed for a long time is that the extensive header information in IP protocols places a particularly heavy load on expensive mobile radio channels. Compression of these headers is thus desirable, especially for transmission via wire-free connections.

In this case, the abbreviation IP stands for Internet Protocol, a protocol in the TCP/IP family in Layer 3 of the OSI reference model. IP is responsible for the connectionless transport of data from the transmitter via a number of networks to the receiver, with no error identification or correction being carried out, that is to say IP is not concerned about damaged or lost packets. IP is used by a number of higher-level protocols, mainly by TCP, but also by UDP.

The datagram is defined as the central data-carrying unit in the IP, and may have a length of up to 65535 bytes. Data to be transmitted is taken from protocols above IP (for example TCP or UDP) and is fragmented by the transmitter, that is to say it is broken down into datagrams. At the receiver end, these datagrams are reassembled, which is referred to as defragmentation. IP is independent of the medium that is used, and is equally suitable for LANs (Local Area Networks) or for WANs (Wide Area Networks).

The header is in this case that part of a data packet which does not contain any payload data, but only various administrative data, such as the address, packet number, transmitter identifier, packet status etc. The data for error identification and/or for error correction (for example checksums CRC) are generally included in the payload data.

TCP is a connection-oriented transport protocol which allows a logical full-duplex point-to-point connection. This ensures that data is transmitted without errors and in the desired sequence via a subordinate IP network. It adds functions for data protection and connection control to the lower-level IP.

UDP is an abbreviation for User Datagram Protocol and refers to a connectionless application protocol for transporting datagrams in the IP family. Like TCP as well, it is built on IP. In comparison to the considerably more widely used TCP, UDP has no error identification or correction, but thus operates more quickly and has a smaller header, for which reason the overhead is reduced and the ratio of the number of payload data items to the packet length is better. UDP is more suitable for applications which send short messages and can if necessary repeat them completely, or for applications which have to be carried out in real time (speech or video transmission).

For specific applications, for example in the real-time area, the application can be supported for error identification and error correction by further, specific protocols in higher layers, for example the RTP (Real Time Protocol). The fundamental principle RTP is the use of forward error control. This is made possible by an enlarged header, which contains additional information. This information includes, for example, the nature of the transmitted payload data (speech, picture data etc) or the time at which the data was produced, so that it is easier to organize the data into a specific correct sequence and to dispose of it after a specific time has elapsed.

One known protocol header compression method can be found, for example, in S. Casner and V. Jacobson, “Compressing IP/UDP/RTP Headers for Low-Speed Serial Links”, Network Working Group, Request for Comments: 2508; (which can be found on the Internet at http://www.ietf.org/rfc/rfc2508.txt?number=2508).

In this case, different codings have been proposed for different protocols. For example, separate compression is carried out for RTP headers from end-to-end connections, while joint compression of RTP/UDP/IP headers is possible for link-to-link connections.

Coding with three different code levels is provided in this case:

a complete header (full header FH)

differential first-order coding (first order difference FO), namely the description of two successive headers by a variable length code, and

differential second-order coding (second order difference SO), that is to say the transmission of the differences between two FO headers.

Once an uncompressed header has been transmitted, changed fields are described by differential coding for compression of TCP headers, in order to reduce their size. Furthermore, changed fields are completely eliminated by calculating changes on the basis of the length of a packet. This is based on the knowledge that approximately half the bytes in IP and TCP headers remain unchanged for the duration of a connection. RTP headers are compressed in a similar way by a decoder reconstructing the complete header on the basis of FO information and SO information In addition, the invention makes use of the fact that, despite there being a number of changed fields in each data packet, the difference from one packet to the next is frequently constant, so that the second order difference SO is zero. In cases such as these, only an uncompressed header and the respective first order differences FO are stored, and information is signaled that the second order difference SO is zero.

This has the disadvantage, inter alia, that these known compression methods are intended specifically for specific protocols of this type and operate only for them. Different encoders must in each case be provided for the different variants of the coding of individual protocols, or a number of them jointly, which increases the complexity and has a negative effect on the economics.

The object of the present invention is therefore to provide a capability for compressing header information which can be used equally efficiently, and hence more economically, irrespective of the particular protocol type.

According to the present invention, this object is achieved by a method for compression of header information in network protocols having the following steps:

transmission of a complete header during the setting up of a connection, as well as transmitter-end and receiver-end use of this header as a reference,

coding by transmitter-end segmentation of each further header into changed fields and unchanged fields with respect to the respectively preceding header, with a cohesive area of changed symbols which has intervals of at most m unchanged symbols being classified as a changed field and a cohesive area of at least m+1 unchanged symbols being classified as an unchanged field,

prediction of the positions of these fields from the fields of the preceding header,

differential transmission of the current header by transmitting a feature for each predicted position, which feature signals whether a position has changed.

In this case, it has been found to be advantageous for a value m=2 to be chosen for intervals of at most m unchanged symbols for classification as a changed field.

One development is distinguished in that a complete header being transmitted once again as required at intervals which can be predetermined during a transmission, and is used as a new reference at the transmitter end and at the receiver end.

According to a further advantageous refinement, in addition to each feature which is transmitted for a predicted position,

if a changed field occurs when the position has not changed, the content of the changed part of this field is transmitted, and

if a changed field or an unchanged field occurs when the position has changed, a length code is in each case transmitted in order to describe the length of an unchanged part, and/or a length code is transmitted in order to describe a changed part as well as the content of the changed part.

In this case, it has been found to be advantageous for each feature which is transmitted for a predicted position being one bit and each length code indicates the length of the respective area of a field in a number of bits, whose size is governed to be

[log₂ (Area−m)]

Alternatively, one byte may also be used as the smallest coding unit, with each feature which is transmitted for a predicted position being one byte, and with field lengths being determined in units of bytes. In many cases, this leads to narrower value ranges and hence to more effective coding.

If, changed fields having an adjacent symbol added to them if the position has changed, when coding of this supplemented field is less complex than coding of the changed position, then the efficiency can be further improved.

This is achieved particularly advantageously if [log₂ (total of the −m required to describe the field length)] is greater than or equal to 2.

According to a further advantageous refinement of the method according to the present invention, error-identifying and/or error-correcting codes which are contained in a protective header stream that is to be transmitted, in particular checksums, also are compressed.

If the compressed data stream has error-identifying and special error-correcting protection mechanisms added to it when required, then the transmission reliability can be further improved.

Building on this, header information which has been compressed in accordance with the invention in network protocols is decompressed by each header being reconstructed at the receiver end on the basis of headers which follow the reference header and the differentially transmitted information.

The method according to the invention as described above can be used particularly advantageously in appropriate encoders and decoders, which in turn can preferably be used as components of transmitting or receiving units, for example in mobile communications terminals.

Inter alia, the method makes use of the fact that long cohesive areas remain unchanged in protocol headers, and the position of the changing areas frequently remains unchanged. In cases such as this, the positions do not need to be transmitted.

This approach according to the invention allows either the compression of individual protocols (for example RTP for end-to-end connections) or of a number of interleaved protocols (IP/UDP/RTP for link-to-link connections). In the same way, it allows tunneled protocols (that is to say the interleaving of a number of IP headers) to be used directly and without any change to the coding method.

Further advantages and details of the invention will become evident from the following comprehensive description and in conjunction with the figures in which, in detail:

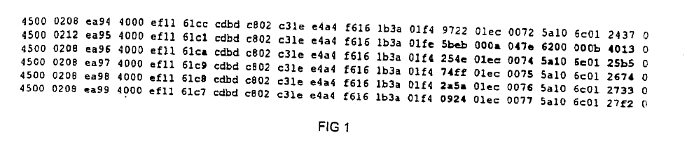

FIG. 1 shows a data extract in the form of a hexadecimal listing of RTP/UDP/IP headers in order to illustrate statistical changes,

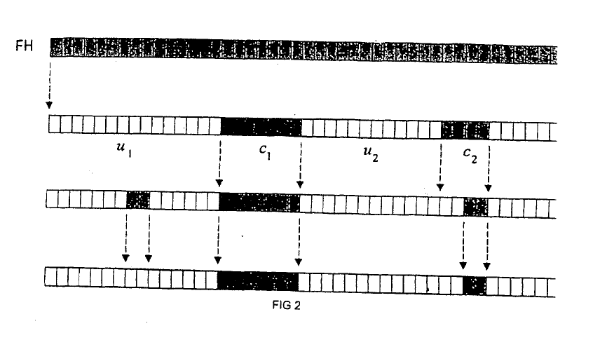

FIG. 2 shows an outline illustration of a sequence of headers in order to illustrate the coding of changed and unchanged fields, and

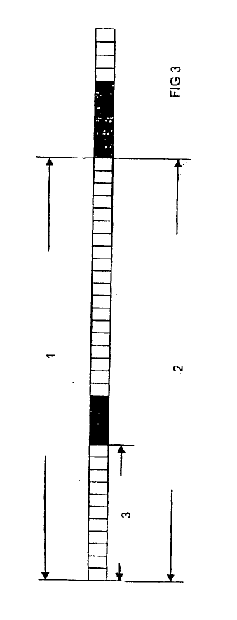

FIG. 3 shows an outline illustration of the code for the field length.

The proposed coding method according to the invention uses statistical characteristics of any given network protocols, without needing any special knowledge of the significance of individual protocol fields. In general, network protocols have long cohesive areas which remain unchanged. In addition, many fields contain the value zero. Changed fields are frequently grouped in intervals which are separated from one another by a long distance The illustration in FIG. 1 shows this on the basis of an example of a listing with hexadecimal data for a number of successive RTP/UDP/IP headers, which are shown line-by-line. The numerical values printed in bold text represent changed information, while the others remain unchanged.

Such unchanged areas are thus predicted from the previous header and do not need to be transmitted. In addition, the position of the changed and unchanged fields is predicted, so that in most cases there is no need to transmit the position coordinates. This principle results in a high level of data compression since only the changed data and a small overhead need be transmitted.

In detail, the method is carried out as follows:

An entire header is transmitted completely for initialization when setting up a connection, and specific intervals when necessary.

Differential coding is then carried out by the following headers being transmitted differentially. Encoders and decoders store the complete preceding header as a reference variable in a reference memory.

To do this, the current header is initially segmented into changed and unchanged fields, as follows:

A cohesive area of bits which have changed from the previous header and have intervals of at most m unchanged bits is classified as a changed field or c field c-F. Short unchanged intervals of length m are included in the c fields, since separate coding is ineffective (see the following paragraph, in this context). A suitable value is in this case m=2.

An unchanged field or u field u-F is defined as a cohesive area of at least m+1 unchanged bits. FIG. 2 illustrates this procedure on the basis of a sequence of headers, with the complete header FH being shown first of all, in the first line. Subsequent headers are shown in the other lines, with changed bits being illustrated in darkened form. A subdivision into corresponding fields u-F and c-F is first carried out, whose positions and lengths change. The positions of the changed and unchanged fields are predicted, as indicated by arrows. Two changed fields c1, c2 and two unchanged fields u1, u2 are in each case shown for this purpose.

For the actual coding, the positions of the fields are predicted from the positions of the fields in the previous header. A feature M (for example one bit), which signals whether the position has changed, is transmitted for each predicted position.

For this purpose, the code for one field may appear as follows:

if the position has not changed:

| | | |
|---|---|---|
| u-field | Value M = 0 | (1 bit) |
| c-field | Value M = 0 | (1 bit) |
| | and the content of the | |
| | changed part | |
| | (uncoded) | |

If the position has changed:

for a u-field or c-field

| | |
|---|---|
| Value M = 1, | (1 bit) |
| Length of the unchanged | (length code) |
| part | |
| Length of the changed | (length code) |
| part | |
| Content of the changed | (uncoded) |
| part | |
| Rest of the field in | |
| the same manner | |

The length code is in this case defined, for example, as follows: po The length code indicates the length of the field in bits. The number of bits required for coding the field length is obtained from the value range in accordance with the following calculation rule, by means of the base-2 logerithm:

Number of bits=[log₂ (value range−m)]

The square brackets in this case indicate that the determined value is rounded up to the next-higher integer value.

The value range is the set of numbers required to describe the length. This depends on the size of the field. In this context, FIG. 3 shows an outline illustration of code for the field length, likewise for illustrative purposes. An area 1 denotes a field u-F, which is predicted will not change. The area 2 indicates the value range, that is to say said set of numbers required to describe the length. Finally, the area 3 signals the actual number of unchanged bits in the area 1.

Example: let us assume that a new position is intended to be determined within a field of length 20, this requires 5 bits.

The coding efficiency can be increased by the following variant, provided that it is assumed that the probability of a change to a bit is 50% on the basis that the probability of the values in the c field is uniformly distributed. The positions of the c fields (the field edges) thus change just as frequently and would need to be recoded every alternate case.

In order to avoid this, the c field should have an adjacent bit added to them if the coding of this bit is less complex than the coding of the changed position. This is the case when,

[log₂ (value range−m)] is greater than or equal to 2.

In most protocols, the information is segmented into bytes. The proposed method can be applied in the same way to bytes instead of bits as the smallest coding unit. To do this, the field lengths are calculated in units of bytes, which leads to smaller value ranges and more effective coding. In this case, there is no need to add an adjacent element to the c fields. However, this has the disadvantage that the entire byte must be renewed in a situation where only one bit changes.

The algorithm can likewise be applied without any change to differential second-order coding, as is known from the initially described prior art.

Furthermore, the described method according to the invention can also be applied to a protected header stream. For example, checksums are also coded and can be evaluated after the decoding process. Furthermore, the compressed data stream can be combined with error protection mechanisms, as required.

The method thus has the potential for a new standard for compression of network protocol headers. It is universally applicable to individual headers, combined or tunneled headers.

1. A method for compression of header information in network protocols having the following steps:
transmission of a complete header (FH) during the setting up of a connection, as well as transmitter-end and receiver-end use of this header as a reference,
coding by transmitter-end segmentation of each further header into changed fields (c-F; c1, c2) and unchanged fields (u-P; u1, u2) with respect to the respectively preceding header, with a cohesive area which has changed symbols and intervals of at most m unchanged symbols being classified as a changed field (c-F) and a cohesive area of at least m+1 unchanged symbols being classified as an unchanged field (u-F),
prediction of the positions of these fields (u-F, c-F) from the field of the preceding header,
differential transmission of the current header by transmitting a feature (M) for each predicted position, which feature (M) signals whether a position has changed.

2. The method for compression of header information in network protocols as claimed in claim 1, with a value m=2 being chosen for intervals of at most m unchanged symbols for classification as a changed field (c-F).

3. The method for compression of header information in network protocols as claimed in claim 1 or 2, with a complete header (FH) being transmitted once again as required at intervals which can be predetermined during a transmission, and being used as a new reference at the transmitter end and at the receiver end.

4. The method for compression of header information in network protocols as claimed in one of the preceding claims
with, in addition to each feature (M) which is transmitted for a predicted position,
if a changed field (c-F) occurs when the position has not changed, the content of the changed part of this field is transmitted, and
if a changed field (c-F) or an unchanged field (u-F) occurs when the position has changed, a length code is in each case transmitted in order to describe the length of an unchanged part, and/or a length code is transmitted in order to describe a changed part as well as the content of the changed part. The content of the changed part of this field is transmitted, and
if a changed field (c-F) or an unchanged field (u-F) occurs when the position has changed, a length code is in each case transmitted in order to describe the length of an unchanged part, and/or a length code is transmitted in order to describe a changed part as well as the content of the changed part.

5. The method for compression of header information in network protocols as claimed in claim 4, with each feature (m) which is transmitted for a predicted position being one bit and each length code indicating the length of the respective area of a field in a number of bits, whose size is governed by
[log₂ (Area−m)]
with [x] representing a rounding operation in which the number x is rounded up to the next higher interger value.

6. The method for compression of header information in network protocols as claimed in claim 4, with one byte being used as the smallest coding unit, with each feature (M) which is transmitted for a predicted position being one byte, and with field lengths being determined in units of bytes.

7. The method for compression of header information in network protocols as claimed in one of claims 1 to 5, with changed fields (c-F) having an adjacent symbol added to them if the position has changed, when coding of this supplemented field is less complex than coding of the changed position.

8. The method for compression of header information in network protocols as claimed in claim 7, with an adjacent symbols always being added when [log₂ (total of the −m required to describe the field length)] is greater than or equal to 2, where [x] representing a rounding operation in which the number x is rounded up to the next-higher integer value.

9. The method for compression of header information in network protocols as claimed in one of the preceding claims, with error-identifying and/or error-correcting codes which are contained in a protective header stream that is to be transmitted, in particular checksums, also being compressed.

10. The method for compression of header information in network protocols as claimed in one of the preceding claims, with the compressed data stream having error-identifying and/or error-correcting protection mechanisms added to it when required.

11. A method for decompression of header information, which has been compressed in accordance with one of the above claims, in network protocols, in which a respective header which is being compressed as claimed in one of the preceding claims is reconstructed at the receiver end on the basis of headers which follow the complete header (FH) and the differentially transmitted information.

12. An encoder for compression of header information in network protocols, with the encoder being designed such that a method as claimed in one of the preceding claims 1 to 10 can be carried out.

13. A decoder for decompression of header information, which has been compressed in accordance with one of the preceding claims 1 to 10, in network protocols, in that each header which has been compressed as claimed in one of claims 1 to 10 can be reconstructed on the basis of headers which follow the received reference header (FH) and the differentially transmitted information.

14. A transmitting unit having an encoder as claimed in claim 12.

15. A receiving unit having a decoder as claimed in claim 13.
